(19) United States
(12) Patent Application Publication
(10) Pub. No.: US 2019/0073134 A1
(43) Pub. Date: Mar. 7, 2019

(54) METHODS FOR RESETTING A FLASH MEMORY DEVICE AND APPARATUSES USING THE SAME

(71) Applicant: Silicon Motion, Inc., Jhubei City (TW)

(72) Inventors: Chang-Wei SHEN, Taoyuan City (TW); Yi-Da CHEN, New Taipei City (TW)

(21) Appl. No.: 15/924,504

(22) Filed: Mar. 19, 2018

(30) Foreign Application Priority Data
Sep. 1, 2017 (TW) 106129947

(51) Int. Cl. G06F 3/06

(52) U.S. Cl. CPC G06F 3/0608; G06F 2212/2022; G06F 3/0679; G06F 3/0641

(57) ABSTRACT

The invention introduces a method for resetting a flash memory device, performed by a controller of a host, including at least the following steps: driving a memory controller to perform fewer than a maximum number of normal resets after receiving a hardware reset command from a processor; and driving the memory controller to perform a super reset when the normal resets are unsuccessful.

### CROSS REFERENCE TO RELATED APPLICATIONS

This application claims priority of Taiwan Patent Application No. 106129947, filed on Sep. 1, 2017, the entirety of which is incorporated by reference herein.

### BACKGROUND

### Technical Field

The present invention relates to flash memory, and in particular to methods for resetting a flash memory device and apparatuses using the same.

### Description of the Related Art

Flash memory devices typically include NOR flash devices and NAND flash devices. NOR flash devices are random access—a host accessing a NOR flash device can provide the device any address on its address pins and immediately retrieve data stored in that address on the device's data pins. NAND flash devices, on the other hand, are not random access but serial access. It is not possible for NOR to access any random address in the way described above. Instead, the host has to write into the device a sequence of bytes which identifies both the type of command requested (e.g. read, write, erase, etc.) and the address to be used for that command. The address identifies a page (the smallest chunk of flash memory that can be written in a single operation) or a block (the smallest chunk of flash memory that can be erased in a single operation), and not a single byte or word. Actually, NAND flash devices usually read or program several pages of data from or into memory cells at one time. Sometimes, the firmware stored in a RAM (Random Access Memory) of the NAND flash device for operating an access interface connecting to the memory cells may contain error bits and must be updated with a copy stored in a NAND storage unit by a reset procedure. However, the firmware stored in the NAND storage unit may be damaged to cause a deadlock in the reset procedure. Accordingly, what is needed are methods for resetting a flash memory device and apparatuses that use these methods to address the above problems.

### BRIEF SUMMARY

An embodiment of the invention introduces a method for resetting a flash memory device, performed by a controller of a host, including at least the following steps: driving a memory controller to perform fewer than a maximum number of normal resets after receiving a hardware reset command from a processor; and driving the memory controller to perform a super reset when the normal resets are unsuccessful.

An embodiment of the invention introduces an apparatus for resetting a flash memory device including at least an access interface coupled to a processor, an interconnect layer coupled to a memory controller, and a controller coupled between access interface and the interconnect layer. The controller drives a memory controller to perform fewer than a maximum number of normal resets after receiving a hardware reset command from a processor; and drives the memory controller to perform a super reset when the normal resets are unsuccessful.

An embodiment of the invention introduces a method for resetting a flash memory device, performed by a microprocessor of a memory controller, including at least the following steps: after receiving a reset command from a host side through an interconnect layer, determining whether the reset command is a normal reset command or a super reset command; when the reset command is a normal reset command, reading first firmware from a storage unit through an access interface of the memory controller, and overwriting second firmware of a RAM (Random Access Memory) of the memory controller with the first firmware; and when the reset command is a super reset command, acquiring third firmware from an electronic apparatus outside of the flash memory device and overwriting the second firmware of the RAM with the third firmware.

An embodiment of the invention introduces an apparatus for resetting a flash memory device including at least an access interface coupled to a storage unit; an interconnect layer coupled to a host side; a RAM; and a microprocessor, coupled between the access interface, the interconnect layer and the RAM. a microprocessor, coupled between the access interface, the interconnect layer and the RAM. The microprocessor, after receiving a reset command from the host side through the interconnect layer, determining whether the reset command is a normal reset command or a super reset command; when the reset command is a normal reset command, reading first firmware from the storage unit through the access interface, and overwriting second firmware of the RAM with the first firmware; and when the reset command is a super reset command, acquiring third firmware from an electronic apparatus rather than the storage unit and the RAM, and overwriting the second firmware of the RAM with the third firmware.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 is the system architecture of electronic equipment according to an embodiment of the invention.

FIGS. 2A and 2B illustrate flowcharts of a method for resetting a flash memory device, which is performed by a controller of a host side, according to an embodiment of the invention.

FIG. 3 is a schematic diagram for storing program code according to an embodiment of the invention.

FIG. 4 is a flowchart illustrating a method for resetting a flash memory device, which is performed by a microprocessor of a memory controller, according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

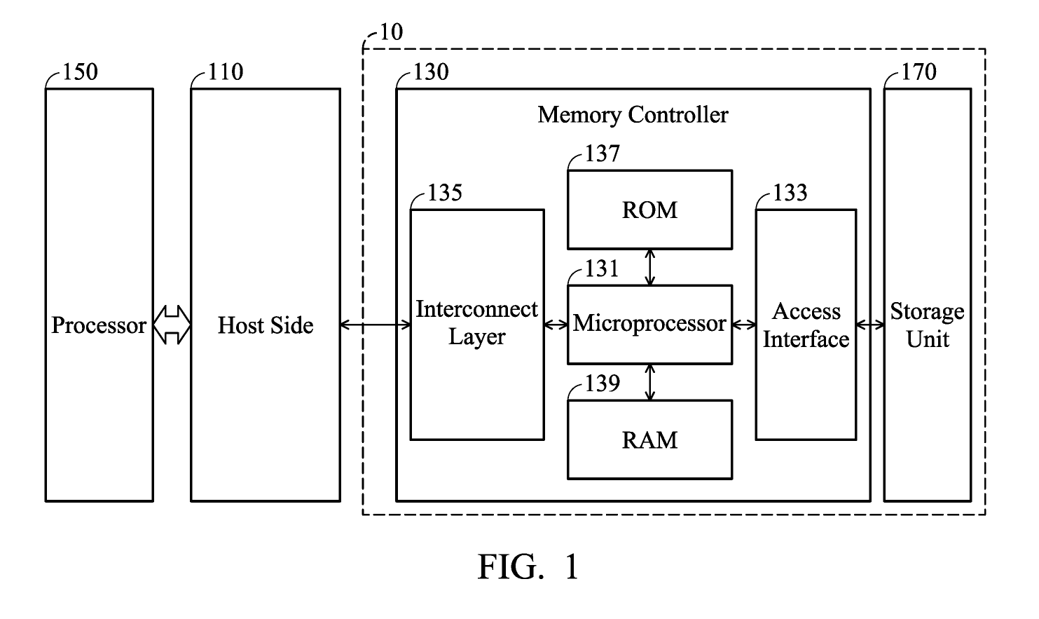

FIG. 1 is the system architecture of electronic equipment according to an embodiment of the invention. The electronic equipment may be equipped with a digital camera, a mobile phone, a consumer electronic device, or others. The flash memory device 10 contains a memory controller 130 and a storage unit 170. The system architecture of the electronic equipment contains a host side 110 and the memory controller 130 communicating with each other through a flash interface. The flash interface may be UFS (Universal Flash Storage) interface, eMMC (Embedded MultiMediaCard) interface, or others. UFS and eMMC are common flash storage specifications to bring higher data transfer speed and increased reliability to flash memory storage and remove the need for different adapters for different types of flash storage units. The memory controller 130 may contain an interconnect layer 135. The interconnect layer 135 may contain a PHY (physical) (L1) layer, a PA (physical adapter) (L1.5) layer and a DL (data link) (L2) layer. The PHY layer may use a differential output pair to transmit data to a peer side and a differential input pair to receive data from the peer side. For example, the PHY layer of the memory controller 130 may transmit data to the host side 110 via the differential output pair and receive data from the host side 110 via the differential input pair. It should be noted that the host side 110 may contain an interconnect layer associated with the memory controller 130.

The host side 110 may further contain an access interface to communicate with a processor 150 of the other electronic equipment through the access interface using a standard protocol, such as USB (Universal Serial Bus), ATA (Advanced Technology Attachment), SATA (Serial ATA), PCI-E (Peripheral Component Interconnect Express) or others. The host side 110 may contain a controller between the access interface and the interconnect layer and implemented in numerous ways, such as a general-purpose processor, a MCU (micro-controller unit), etc., that is programmed using microcode or software/firmware instructions to drive the interconnect layer to transmit UFC or eMMC commands and data to the memory controller 130 and receive data and messages from the memory controller 130 in response to commands received from the processor 150.

A microprocessor 131 of the memory controller 130 may communicate with a storage unit 170 using a DDR (Double Data Rate) protocol, such as ONFI (open NAND flash interface), DDR toggle, or others, via an access interface 133. The microprocessor 131 may be a general-purpose processor or a MCU. The microprocessor 131 loads firmware from the storage unit 170 and stores in a RAM in a system boot. When receiving a UFS or eMMC command and data from the host side 110, the microprocessor 131 executes relevant codes to write data into a designated address of the storage unit 170, and read data from a designated address thereof by directing the access interface 133. The access interface 133 uses several electrical signals for coordinating commands and data transfer between the microprocessor and the storage unit 170, including data lines, a clock signal and control lines. The data lines are employed to transfer commands, addresses and data to be written and read. The control lines are utilized to issue control signals, such as CE (Chip Enable), ALE (Address Latch Enable), CLE (Command Latch Enable), WE (Write Enable), etc.

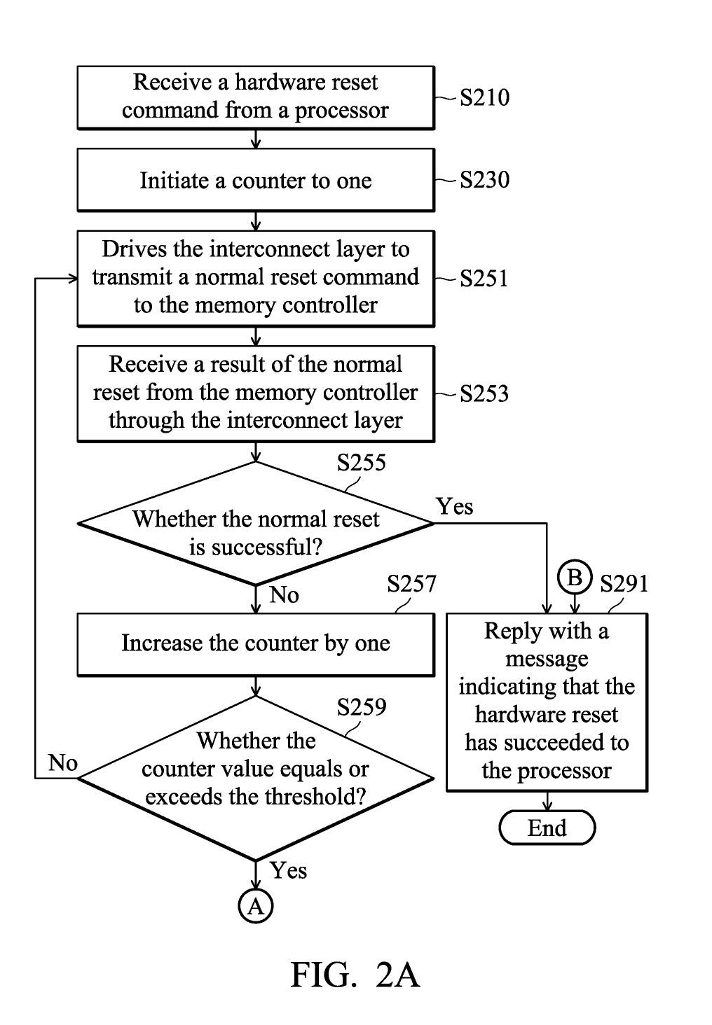

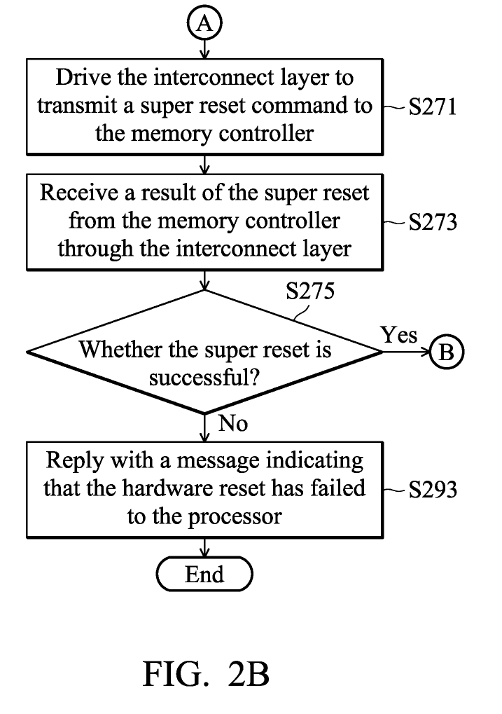

Since the flash memory has operated for a time period, firmware stored in the RAM may be damaged. Therefore, in some implementations, the processing unit 150 may issue a hardware reset command for renewing the firmware of the DRAM with the firmware of the storage unit 170. However, if the firmware of the storage unit 1170 has been damaged, the aforementioned hardware reset will cause a deadlock. To address the aforementioned problem, FIGS. 2A and 2B illustrate flowcharts of a method for resetting a flash memory device, which is performed by a controller of a host side, according to an embodiment of the invention. After receiving the hardware reset command from the processor 150 via a host-side access interface (step S210), the controller of the host side 110 initiates a counter to one (step S230), and then, repeatedly executes a loop for driving the memory controller 130 to perform fewer than a maximum number of normal resets (steps S251 to S259). When it is still unsuccessful after the number of times of normal resets, the controller of the host side 110 drivers the memory controller 130 to perform a super reset (steps S271 to S275). In each iteration of the loop, specifically, the controller of the host side 110 drives an interconnect layer of the host side 110 to transmit a normal reset command to the memory controller 130 (step S251), receives a result of the normal reset from the memory controller 130 through the interconnect layer of the host side 110 (step S253), and determines whether the normal reset is successful according to the result of the normal reset (step S255). When the normal reset is successful (the “Yes” path of step S255), the loop ends and the controller of the host side 110 replies with a message indicating that the hardware reset has succeeded to the processor 150 through the host-side access interface (step S291). When the normal reset fails (the “No” path of step S255), the controller of the host side 110 increases the counter by one (step S257), and determines whether the counter value equals or exceeds a threshold (step S259). When the counter value does not exceed the threshold (the “No” path of step S259), the next iteration of the loop is performed.

When the counter value equals or exceeds the threshold (the “Yes” path of step S259), the loop ends and the controller of the host side 110 drives the interconnect layer of the host side 110 to transmit a super reset command to the memory controller 130 (step S271), receives a result of the super reset from the memory controller 130 through the interconnect layer of the host side 110 (step S273) and determines whether the super reset is successful according to the result of the super reset (step S275). When the super reset is successful (the “Yes” path of step S275), a message indicating that the hardware reset has succeeded is replied to the processor 150 through the host-side access interface (step S291). When the super reset fails, a message indicating that the hardware reset has failed is replied to the processor 150 through the host-side access interface (step S293).

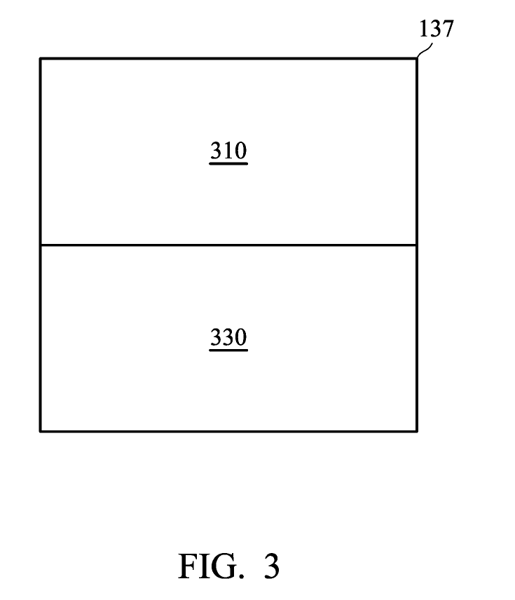

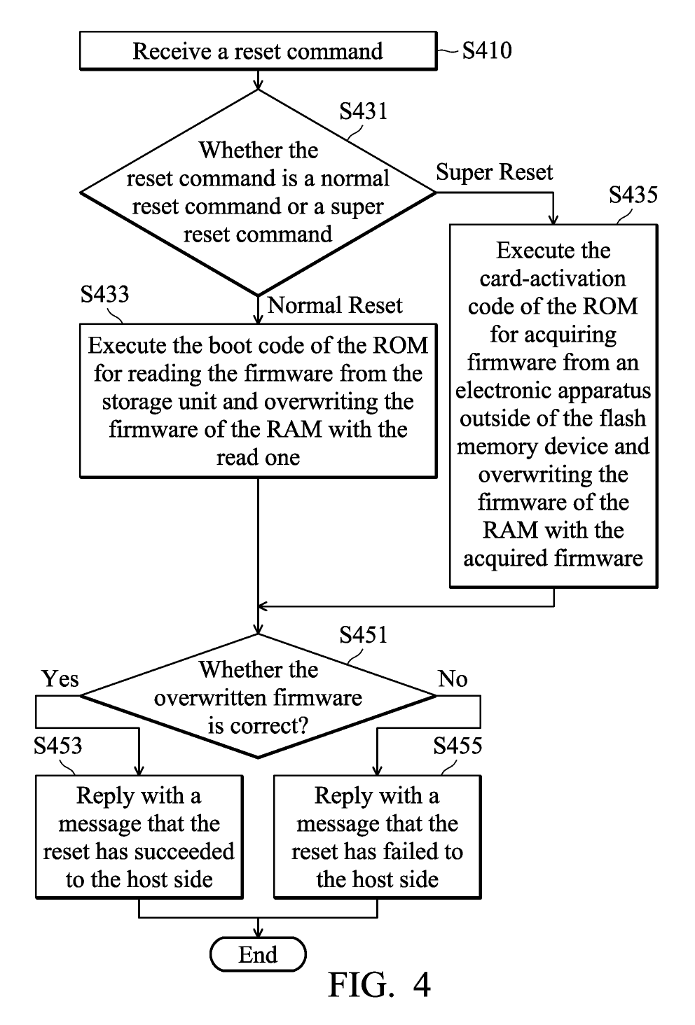

In some embodiments, the normal reset command of step S251 and the super reset command of step S271 may be different UFS or eMMC commands. In alternative embodiments, the normal reset command of step S251 and the super reset command of step S271 may be distinguished by different reset-type flags of the same UFS or eMMC command. For example, the reset-type flag being “0” of the UFS or eMMC command indicates a normal reset command. The reset-type flag being “1” of the UFS or eMMC command indicates a super reset command. Details of the normal reset and the super reset that are performed by the memory controller 130 are described as follows: FIG. 3 is a schematic diagram for storing program code according to an embodiment of the invention. The ROM (Read Only Memory) 137 includes two regions 310 and 330. The region 310 stores boot code while the region 330 stores card-activation code. FIG. 4 is a flowchart illustrating a method for resetting a flash memory device, which is performed by a microprocessor of a memory controller, according to an embodiment of the invention. After receiving a reset command through the interconnect layer 135 (step S410), the microprocessor 131 determines whether the reset command is a normal reset command or a super reset command (step S431). When the received UFS or eMMC command is a normal reset command (the “Yes” path of step S431), the boot code of the region 310 of the ROM 137 is executed for reading the firmware from the storage unit 170 and overwriting the firmware of the RAM 139 with the read one (step S433). When the received UFS or eMMC command is a super reset command (the “No” path of step S431), the card-activation code of the region 330 of the ROM 137 is executed for acquiring firmware from an electronic apparatus outside of the flash memory device 10 and overwriting the firmware of the RAM 139 with the acquired firmware (step S435). In step S435, the firmware may be downloaded from a download site connecting to Internet or LAN (Local Area Network) or may be acquired from another storage device of electronic equipment that installs the flash memory device 10. In step S435, the microprocessor 131 further drives the access interface 133 to program the acquired firmware into the storage unit 170 to replace the original one. After the firmware of the RAM 139 is overwritten (step S453 or S455), it is determined whether the overwritten firmware is correct (step S451). When the overwritten firmware is correct (the “Yes” path of step S451), the interconnect layer 135 is driven to reply with a message that the reset has succeeded to the host side 110 (step S453). When the overwritten firmware is incorrect (the “No” path of step S451), the interconnect layer 135 is driven to reply with a message that the reset has failed to the host side 110 (step S455). The firmware may contain CRC (Cyclic Redundancy Check) code, and, in step S451, the microprocessor 131 may use a decoder to exam the CRC code of the firmware of the RAM 139 to determine whether the firmware is correct.

Although the embodiment has been described as having specific elements in FIG. 1, it should be noted that additional elements may be included to achieve better performance without departing from the spirit of the invention. While the process flows described in FIGS. 2A, 2B and 4 include a number of operations that appear to occur in a specific order, it should be apparent that these processes can include more or fewer operations, which can be executed serially or in parallel (e.g., using parallel processors or a multi-threading environment).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for resetting a flash memory device, which is performed by a controller of a host side, comprising:
driving a memory controller to perform fewer than a maximum number of normal resets after receiving a hardware reset command from a processor; and
driving the memory controller to perform a super reset when the normal resets are unsuccessful.

2. The method of claim 1, wherein a microprocessor of the memory controller reads first firmware from a storage unit through an access interface of the memory controller, and overwrites second firmware of a RAM (Random Access Memory) of the memory controller with the first firmware when the normal reset is performed.

3. The method of claim 2, wherein the microprocessor of the memory controller acquires third firmware from an electronic apparatus outside of the flash memory device and overwrites the second firmware of the RAM with the third firmware when the super reset is performed.

4. The method of claim 1, wherein the controller of the host side drives an interconnect layer of the host side to transmit a normal reset command for driving the memory controller to perform the normal reset.

5. The method of claim 4, comprising:
determining that the normal reset is successful when receiving a message indicating that a hardware reset has succeeded from the memory controller through the interconnect layer of the host side.

6. The method of claim 4, wherein the controller of the host side drives an interconnect layer of the host side to transmit a super reset command for driving the memory controller to perform the super reset.

7. The method of claim 6, wherein the normal reset command and the super reset command are different UFS (Universal Flash Storage) or eMMC (Embedded MultiMediaCard) commands.

8. The method of claim 6, wherein the normal reset command and the super reset command are distinguished by different reset-type flags of the same UFS (Universal Flash Storage) or eMMC (Embedded MultiMediaCard) command.

9. The method of claim 1, wherein the step of driving the memory controller to perform less than the number of times of normal resets comprises:
after each time driving the memory controller to perform the normal reset, determining whether the normal reset is successful;
increasing a counter by one when the normal reset fails; and
determining that the normal resets have failed when the counter equals or exceeds a threshold.

10. A method for resetting a flash memory device, which is performed by a microprocessor of a memory controller, comprising:
after receiving a reset command from a host side through an interconnect layer, determining whether the reset command is a normal reset command or a super reset command;
when the reset command is a normal reset command, reading first firmware from a storage unit through an access interface of the memory controller, and overwriting second firmware of a RAM (Random Access Memory) of the memory controller with the first firmware; and
when the reset command is a super reset command, acquiring third firmware from an electronic apparatus outside of the flash memory device and overwriting the second firmware of the RAM with the third firmware.

11. The method of claim 10, comprising:
determining whether the third firmware is correct;
driving the interconnect layer of the memory controller to transmit a message indicating that a super reset has succeeded to the host side when the third firmware is correct; and
driving the interconnect layer of the memory controller to transmit a message indicating that the super reset has failed to the host side when the third firmware is incorrect.

12. The method of claim 11, wherein the memory controller examines CRC (Cyclic Redundancy Check) code of the third firmware to determine whether the third firmware is correct.

13. The method of claim 10, comprising:
when the reset command is a super reset command, driving the access interface to program the third firmware into the storage unit to replace the first firmware.

14. The method of claim 10, comprising:
when the reset command is a normal reset command, executing code of a first region of a ROM (Read Only Memory) of the memory controller for reading the first firmware from the storage unit through the access interface of the memory controller, and overwriting the second firmware of the RAM of the memory controller with the first firmware; and
when the reset command is a super reset command, executing code of a second region of the ROM of the memory controller for acquiring the third firmware from the electronic apparatus outside of the flash memory device and overwriting the second firmware of the RAM with the third firmware.

15. The method of claim 10, wherein the normal reset command and the super reset command are different UFS (Universal Flash Storage) or eMMC (Embedded MultiMediaCard) commands.

16. The method of claim 10, wherein the normal reset command and the super reset command are distinguished by different reset-type flags of the same UFS (Universal Flash Storage) or eMMC (Embedded MultiMediaCard) command.

17. The apparatus for resetting a flash memory device, comprising:
an access interface, coupled to a storage unit;
an interconnect layer, coupled to a host side;
a RAM (Random Access Memory); and
a microprocessor, coupled between the access interface, the interconnect layer and the RAM, after receiving a reset command from the host side through the interconnect layer, determining whether the reset command is a normal reset command or a super reset command; when the reset command is a normal reset command, reading first firmware from the storage unit through the access interface, and overwriting second firmware of the RAM with the first firmware; and when the reset command is a super reset command, acquiring third firmware from an electronic apparatus rather than the storage unit and the RAM, and overwriting the second firmware of the RAM with the third firmware.

18. The apparatus of claim 17, wherein the microprocessor drives the interconnect layer to transmit a message indicating that a super reset has succeeded to the host side when the third firmware is correct; and drives the interconnect layer to transmit a message indicating that the super reset has failed to the host side when the third firmware is incorrect.

19. The apparatus of claim 17, wherein the microprocessor drives the access interface to program the third firmware into the storage unit to replace the first firmware when the reset command is a super reset command.

20. The apparatus of claim 17, comprising:
a ROM (Read Only Memory), coupled to the microprocessor;
wherein the microprocessor executes code of a first region of the ROM of the memory controller for reading the first firmware from the storage unit through the access interface of the memory controller, and overwriting the second firmware of the RAM of the memory controller with the first firmware when the reset command is a normal reset command; and executes code of a second region of the ROM for acquiring the third firmware from the electronic apparatus rather than the storage unit and the RAM, and overwrites the second firmware of the RAM with the third firmware when the reset command is a super reset command.
